(19) United States
(12) Patent Application Publication
(10) Pub. No.: US 2026/0346698 A1
(43) Pub. Date: Nov. 5, 2026

(54) ELECTRIC WHEEL HUB DRIVE FOR A MOTOR VEHICLE

(71) Applicant: MERCEDES-BENZ GROUP AG, Stuttgart (DE)

(72) Inventors: Michael SCHMIDT, Wernau (DE); Arthur ADAM, Sindelfingen (DE); Fabian SCHWED, Esslingen am Neckar (DE); Johannes DEHN, Hochdorf (DE); Jessica ROOSZ, Esslingen (DE)

(21) Appl. No.: 19/136,583

(22) PCT Filed: Nov. 17, 2023
(86) PCT No.: PCT/EP2023/082240

§ 371 Date: Jun. 6, 2025

(30) Foreign Application Priority Data
Dec. 7, 2022 (DE) 10 2022 004 587.7

(51) Int. Cl. B60K 7/00

(52) U.S. Cl. CPC B60K 7/0007

(57) ABSTRACT

The invention relates to an electric wheel hub drive for a motor vehicle, having a wheel carrier, having a wheel bearing which has a first bearing ring connected to the wheel carrier for conjoint rotation and a second bearing ring arranged so as to be rotatable with respect to a main rotational axis, having an electric engine which has a stator and a rotor arranged so as to be rotatable around the main rotational axis, having a stator carrier which is connected to the wheel carrier for conjoint rotation, having a rotor carrier which is connected to the rotor for conjoint rotation and is mounted so as to be rotatable with respect to the wheel carrier, wherein a decoupler has a first coupling half connected to the rotor carrier for conjoint rotation and a second coupling half connected to the second bearing ring for conjoint rotation, wherein a servomotor of an actuator of the decoupler is arranged on a side of the wheel carrier facing away from the first and second coupling halves.

### BACKGROUND AND SUMMARY OF THE INVENTION

Exemplary embodiments of the invention relate to an electric wheel hub drive for a motor vehicle.

A decoupler (disconnect unit) can be used in an electric wheel hub drive for a motor vehicle. For example, a servomotor is used for actuating the decoupler.

There is limited installation space available for the integration of the servomotor into the wheel. Additionally, the servomotor is difficult to access when positioned in the wheel, for example for maintenance purposes.

US 2020/0287495 A1 describes a control device for an electric motor having a first set of coil windings, which are arranged to form a first sub-motor, and a second set of coil windings, which are arranged to form a second sub-motor, wherein the current flow in the first set of coil windings is controlled using a first pulse-width modulation (PWM) with a first switching sequence and the current flow in the second set of coil windings is controlled using a second PWM with a second switching sequence, wherein the control device comprises means arranged to measure the current flow in each of the first set of coil windings, wherein after determining that the sum of the current flow in the first set of coil windings is substantially not zero, the first PWM values are deduced from voltage values which are used to create the second PWM.

Furthermore, wheel hub drives are known from JP 2020-128 134 A and DE 10 2022 000 035A1 , in which in each case a decoupler is also provided that has a first coupling half connected to a rotor carrier for conjoint rotation and a second coupling half connected to a wheel rim for conjoint rotation, wherein a servomotor of an actuator of the decoupler is arranged directly on the wheel carrier.

Exemplary embodiments of the invention are directed to a novel electric wheel hub drive for a motor vehicle.

In the context of the present application, the term “for conjoint rotation” is used as follows: Two elements are connected to each other for conjoint rotation when they are arranged coaxially to each other (in relation to their rotational axis or in relation to an axis of rotational symmetry) and when they are connected to each other in such a way that they always rotate at the same angular velocity. An element is connected to a housing for conjoint rotation when it cannot be rotated relative to the housing.

In the context of the present application, the term “radially overlapping” is used as follows: Two (in particular substantially rotationally symmetrical) elements are arranged radially overlapping in relation to a common axis when they are each at least partially arranged in a region of the same radial coordinates (specifically and of the same angular coordinates).

In the context of the present application, the term “axially overlapping” is used as follows: Two elements are arranged axially overlapping with regard to a common axis when they are each at least partially arranged in a region of the same axial coordinates.

In the context of the present application, the term “radially inside” is used as follows: A first element is arranged radially inside a second element, in relation to a common axis, when the first element is arranged in a region of smaller radii than the second element.

According to the invention, an electric wheel hub drive for a motor vehicle is proposed, having a wheel carrier, a wheel rim, a wheel bearing that has a first bearing ring connected to the wheel carrier for conjoint rotation and a second bearing ring arranged so as to be rotatable with respect to a main rotational axis, an electric engine having a stator and a rotor arranged so as to be rotatable around the main rotational axis, a stator carrier connected to the wheel carrier for conjoint rotation, a rotor carrier connected to the rotor for conjoint rotation and is mounted so as to be rotatable with respect to the wheel carrier. In this case, a decoupler is provided, which has a first coupling half connected to the rotor carrier for conjoint rotation and a second coupling half connected to the wheel rim for conjoint rotation, wherein a servomotor of an actuator of the decoupler is arranged directly on the wheel carrier. Therefore, a particularly compact wheel hub drive can be realized, wherein there is easy access to the servomotor for maintenance purposes.

Particularly advantageously, the servomotor is arranged on a side of the wheel carrier facing away from the first and second coupling halves, wherein the servomotor is arranged partially in a recess in the wheel carrier that is provided for this purpose.

A rotational axis of the servomotor is arranged parallel to the main rotational axis in a manner known per se.

In this case, the servomotor has a shaft connected to a rotor of the servomotor for conjoint rotation. According to the invention, the wheel carrier has a drilled hole, wherein the shaft is guided through the drilled hole.

Particularly advantageously, the stator carrier has a disc section arranged on a side of the wheel carrier facing away from the servomotor, wherein the disc section has a passage through which the shaft is guided.

In one embodiment, the actuator has an axial displacement device arranged on a side of the wheel carrier facing away from the servomotor and which is designed to convert a rotational movement of the shaft into an axial movement parallel to the main rotational axis.

In one embodiment, the axial displacement device has a pinion connected to the shaft for conjoint rotation.

In one embodiment, the axial displacement device has a first ramp ring coupled to the pinion via a tooth engagement and a second ramp ring connected to the stator carrier via a groove of the stator carrier for conjoint rotation.

In one embodiment, a cover is arranged over the servomotor on the side thereof facing away from the wheel carrier.

In one embodiment, the second ramp ring has a shift fork engaging into the sliding sleeve so that the sliding sleeve can be moved axially together with the second ramp ring; however, rotation of the sliding sleeve together with the rotor carrier is possible independently of the second ramp ring.

In one embodiment, the first ramp ring has a ramp engaged with a counter-ramp of the second ramp ring so that rotation of the first ramp ring causes an axial movement of the second ramp ring.

A decoupler in the meaning of the present invention comprises two coupling halves (for example, as a claw coupling or form-fitting coupling; alternatively, a multiple-disc coupling or a frictional coupling may also be used). The term “decoupler” can furthermore include a sliding sleeve, wherein the second coupling half of the decoupler can be designed, for example, as gaps and/or holes in the brake disc carrier. The second coupling half can, however, also be designed as a separate claw toothing which is also connected to the second bearing ring for conjoint rotation.

The term “actuator of the decoupler” includes all components mounted upstream of the sliding sleeve: servomotor, adjustment shaft, pinion, axial displacement device (having the pinion, a first ramp ring, a second ramp ring, if necessary, with balls lying in between).

The actuator can be shielded by a protection device, for example a cover, in order to protect it from stone chipping and environmental influences.

A small servomotor in the wheel carrier results in weight and packaging advantages compared to a large ring motor in the drive module.

Exemplary embodiments of the invention are explained in more detail in the following using the drawings.

### BRIEF DESCRIPTION OF THE DRAWING FIGURES

In the figures:

FIG. 1 shows a schematic view of an electric wheel hub drive for a motor vehicle, and

FIG. 2 shows a schematic detailed view of the electric wheel hub drive.

Parts corresponding to each other are provided with the same reference signs in all the figures.

### DETAILED DESCRIPTION

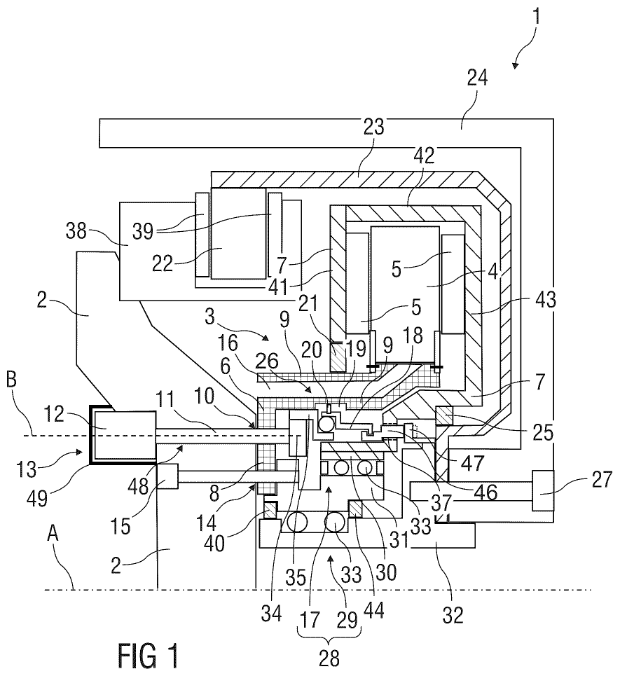

FIG. 1 shows a schematic view of an electric wheel hub drive 1 for a motor vehicle, having a wheel carrier 2, an electric engine 3 having a stator 4 and a rotor 5 arranged so as to be rotatable around a main rotational axis A, a stator carrier 6 connected to the wheel carrier 2 for conjoint rotation, a rotor carrier 7 connected to the rotor 5 for conjoint rotation and is mounted so as to be rotatable with respect to the wheel carrier 2. The stator carrier 6 has a disc section 8 and a cylinder section 9. The cylinder section 9 is arranged radially outside the disc section 8. The disc section 8 has a first passage 10 for a shaft 11 of a servomotor 12 of a decoupler 13, wherein the decoupler 13 is arranged radially inside the cylinder section 9.

In the embodiment shown in FIG. 1, the disc section 8 has second passages 14 for screw connections 15, which are designed to connect the disc section 8 to the wheel carrier 2 for conjoint rotation.

In the embodiment, the second passages 14 are substantially arranged in a region of the same radii as the first passage 10.

In the embodiment, the cylinder section 9 has at least one channel 16, which is designed for receiving a coolant.

In the embodiment, a rotor bearing 17 for rotatably mounting the rotor 5 is provided and is arranged radially inside and axially overlapping the channel 16.

In the embodiment, the decoupler 13 furthermore has a second ramp ring 18 arranged radially inside the cylinder section 9, wherein the second ramp ring 18 is connected to the cylinder section 9 for conjoint rotation and can be moved axially with respect to the cylinder section 9.

In the embodiment, the cylinder section 9 has at least one groove 19 on its radially inner side, which groove runs parallel to the main rotational axis A, wherein the ramp ring 18 is connected to an engagement element 20 which engages into one of the grooves 19.

In one embodiment, the cylinder section 9 has a sealing surface on its radially outer side for a seal 21, in particular a radial seal, with respect to the rotor carrier 7.

In one embodiment, the sealing surface is arranged axially between the stator 4 and a brake disc 22.

The rotor bearing 17 is a part of a combined bearing 28, which further includes a wheel bearing 29, wherein the combined bearing 28 has an outer bearing shell 30, a central bearing ring 31, and an inner bearing ring 32, wherein a plurality of rolling elements 33 is arranged between the outer bearing ring 30 and the central bearing ring 31, which bearing rings form the rotor bearing 17, wherein a plurality of rolling elements 33 is arranged between the central bearing ring 31 and the inner bearing ring 32, which bearing rings form the wheel bearing 29.

The brake disc 22 can be designed as an inside-out brake disc and can be arranged on a brake disc carrier 23, which is connected to a wheel rim 24 for conjoint rotation. The wheel rim 24 and the brake disc carrier 23 are connected to the inner bearing ring 32 of the wheel bearing 29 via several wheel screws 27 for conjoint rotation.

A further radial seal 25 can be arranged between the brake disc carrier 23 and the rotor carrier 7.

The second ramp ring 18 is connected axially fixedly to a shift fork 50, which engages into a groove of a first coupling half 46.

Furthermore, a pinion 34 is arranged on the shaft 11, which pinion is in operative connection with the second ramp ring 18 via a first ramp ring 35. The first ramp ring 35 has splines on an inner circumference engaged with pinion splines of the pinion 34. The first ramp ring is arranged coaxially to the main rotational axis A. A corresponding rotation of the pinion 34 causes a rotation of the first ramp ring 35 around the main rotational axis A. A first ramp of the first ramp ring 35, not shown in more detail, consequently causes axial displacement of the second ramp ring in the direction of the coupling halves 46, 47.

A brake caliper 38 with brake pads 39 is further arranged on the wheel carrier 2. The brake caliper 38 can be designed as an internal brake caliper 38.

The wheel carrier 2, the brake caliper 38, the brake pads 39, the stator 4, the stator carrier 6, the servomotor 12, the shaft 11, the pinion 34, and the central bearing ring 31 do not rotate with the wheel rim 24.

The brake disc 22, the brake disc carrier 23 and the inner bearing ring 32 always rotate together with the wheel rim 24.

The rotor carrier 7, the rotor 5, the first coupling half 46, the ramp ring 18, the engagement element 20, and the outer bearing ring 30 only rotate with the wheel rim 24 when the decoupler 13 is connected.

The electric engine 3 can be designed as an axial flux machine.

To seal a rotor space, in particular an intermediate space between the rotor 5 and the stator 4, a first seal 21 can be provided, which is arranged coaxially to the rotor carrier 7 in such a way that a first intermediate gap is filled by the first seal 21 between the rotor carrier 7 and the stator carrier 6.

A second seal 25 or further radial seal 25 can be arranged coaxially to the rotor carrier 7 in such a way that a second intermediate gap is filled by the second seal 25 between the rotor carrier 7 and the brake disc carrier 23.

With regard to the main rotational axis A, the second seal 25 can be arranged axially on one side of the first seal 21, facing away from the wheel carrier 2.

The second seal 25 can be arranged radially inside the stator 4, which means in particular radially inside the region of magnets arranged in the stator 4.

The first seal 21 can be arranged radially inside the rotor 5, which means in particular radially inside the region of magnets arranged in the rotor 5.

A first connection point for connecting the brake disc carrier 23 to the inner bearing ring 32 can be arranged radially inside the second seal 25.

The brake disc 22, which is connected to the brake disc carrier 23 for conjoint rotation, can be arranged on a side of the first seal 21, opposite the second seal 25, axially with regard to the main rotational axis A.

A third seal 40 can furthermore be arranged coaxially to the rotor carrier 7 in such a way that a third intermediate gap is filled by the third seal 40 between the central bearing ring 31, which can also be referred to as a first bearing ring, and the inner bearing ring 32, which can also be referred to as a second bearing ring.

Furthermore, there may be a second connection point for the sealed connection of the central bearing ring 31 to the stator carrier 6. Thus, the rotor space is closed: the stator carrier 6 has the cylinder section 9, which is sealed by means of the first seal 21 with respect to a first disc-shaped part 41 of the rotor carrier 7, which lies on one side of the stator 4 when viewed axially. The rotor carrier 7 furthermore has a cylindrical part 42 and a second disc-shaped part 43, which is connected to the cylindrical part 42 and which is sealed with respect to the brake disc carrier 23 by means of the second seal 25. The brake disc carrier 23 has a sealed connection point for connection to the inside bearing ring 32. The inner bearing ring 32 is sealed with respect to the central bearing ring 31 by means of the third seal 40. The central bearing ring 31 has the sealed second connection point for connection to the stator carrier 6.

A fourth seal 44 can furthermore be provided between the inner bearing ring 32 and the central bearing ring 31 on the side of the wheel bearing 29 that is axially opposite the third seal 40.

The central bearing ring 31 can be designed as a single, integral bearing ring, which is both a radially outer part of the wheel bearing 29 and also a radially inner part of the rotor bearing 17. Alternatively, the central bearing ring 31 can also be designed as two bearing rings, connected to each other for conjoint rotation, of which one is a radially outer part of the wheel bearing 29 and the other is a radially inner part of the rotor bearing 17.

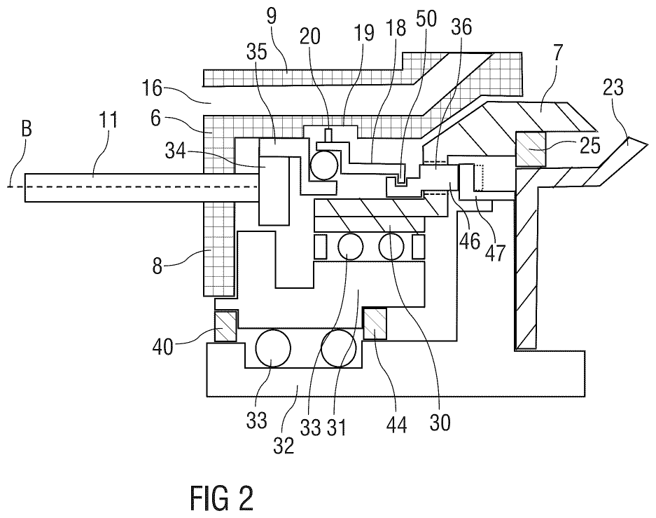

FIG. 2 is a schematic detailed view of the electric wheel hub drive 1.

The decoupler 13 has the first coupling half 46 connected to the rotor carrier 7 for conjoint rotation. The decoupler 13 furthermore has a second coupling half 47 connected to the second bearing ring 32 for conjoint rotation, wherein a servomotor 12 of the decoupler 13 is arranged directly on the wheel carrier 2. The servomotor 12 can be arranged on a side of the wheel carrier 2 facing away from the first and second coupling halves 46, 47.

A rotational axis B of the shaft 11 is arranged parallel to the main rotational axis A.

The shaft 11 is connected to a servomotor rotor of the servomotor 12 for conjoint rotation. In the exemplary embodiment of FIG. 1, the wheel carrier 2 has a drilled hole 48, wherein the shaft 11 is guided through the drilled hole 48.

The disc section 8 is advantageously arranged on a side of the wheel carrier 2 facing away from the servomotor 12, wherein the disc section 8 has the passage 10 through which the shaft 11 is guided.

An axial displacement device 26 is arranged on a side of the wheel carrier 2 facing away from the servomotor 12. The axial displacement device 26 is designed to convert a rotational movement of the shaft 11 into an axial movement parallel to the main rotational axis A.

The axial displacement device 26 comprises the pinion 34, which is connected to the shaft 11 for conjoint rotation. The axial displacement device 26 furthermore comprises the first ramp ring 35 and the second ramp ring 18.

The second ramp ring 18 has a shift fork 50 that engages into a groove of the first coupling half 46, so that the first coupling half can rotate together with the rotor carrier 7, while the second ramp ring 18 does not rotate, wherein the first coupling half 46 can however be moved axially together with the second ramp ring 18.

Rotation of the shaft 11 causes rotation of the first ramp ring 35 via the pinion 34 and the toothing, thereby causing axial movement of the second ramp ring 18 and the first coupling half 46. Depending on the rotational direction of the shaft 11, this engages accordingly in the second coupling half 47 and thus couples the rotor carrier 7 to the brake disc carrier 23 or decouples the rotor carrier 7 from the brake disc carrier 23. A disengaging movement of the first coupling half 46 can take place or be supported for example by a spring acting in the axial direction, which is not shown here.

A cover 49 can be arranged over the servomotor 12.

The first coupling half 46 is connected to the rotor carrier 7 for conjoint rotation, as, in the exemplary embodiment, the first coupling half 46 engages in the rotor carrier 7 through passages 37. The first coupling half 46 is arranged circularly in the region of engagement of the shift fork 50 and coaxially to the main rotational axis A. The first coupling half 46 advantageously has a claw toothing which engages through the rotor carrier 7. The claw toothing of the first coupling half 46 advantageously fits into a further claw toothing, which is part of the second coupling half 47.

Advantageously, the first ramp ring 35 and the second ramp ring 18 are arranged radially inside the cylinder section 9.

The components of the decoupler 13 which are operatively mounted upstream of the first coupling half 46, i.e., the servomotor 12, the shaft 11, the pinion 34, and the axial displacement device (having the pinion 34, the first ramp ring 35, the second ramp ring 18, if necessary, balls placed between the ramp rings 35, 18), together can be referred to as an actuator.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

### LIST OF REFERENCE SIGNS

1 electric wheel hub drive
2 wheel carrier
3 electric engine
4 stator
5 rotor
6 stator carrier
7 rotor carrier
8 disc section
9 cylinder section
10 passage
11 shaft
12 servomotor
13 decoupler
14 passage
15 screw connection
16 channel
17 rotor bearing
18 ramp ring
19 groove
20 engagement element
21 seal, first seal
22 brake disc
23 brake disc carrier
24 wheel rim
25 further radial seal, second seal
26 axial displacement device
27 wheel screw
28 combined bearing
29 wheel bearing
30 outer bearing ring
31 central bearing ring, first bearing ring
32 inner bearing ring, second bearing ring
33 rolling elements
34 pinion
35 ramp ring
37 passage
38 brake caliper
39 brake pad
40 third seal
41 first disc-shaped part
42 cylindrical part
43 second disc-shaped part
44 fourth seal
46 coupling half
47 coupling half
48 drilled hole
49 cover
50 shift fork
A main rotational axis
B rotational axis

1-8. (canceled)

9. An electric wheel hub drive for a motor vehicle, the electric wheel hub drive comprising:
a wheel carrier;
a wheel rim with a wheel bearing, which has a first bearing ring connected to the wheel carrier to conjointly rotate and a second bearing ring arranged rotatable with respect to a main rotational axis;
an electric engine comprising a stator and a rotor arranged so as to be rotatable around the main rotational axis;
a stator carrier connected to the wheel carrier to conjointly rotate;
a rotor carrier connected to the rotor to conjointly rotate and is mounted so as to be rotatable with respect to the wheel carrier; and
a decoupler having a first coupling half connected to the rotor carrier to conjointly rotate and a second coupling half connected to the wheel rim to conjointly rotate,
wherein the decoupler has a servomotor of an actuator arranged directly on the wheel carrier,
wherein a rotational axis of a shaft of the servomotor is arranged parallel to the main rotational axis,
wherein the wheel carrier has a drilled hole,
wherein the shaft is guided through the drilled hole,
wherein the stator carrier has a disc section arranged on a side of the wheel carrier facing away from the servomotor, and
wherein the disc section has a passage through which the shaft is guided.

10. The electric wheel hub drive of claim 9, wherein the actuator has an axial displacement device arranged on a side of the wheel carrier facing away from the servomotor and configured to convert a rotational movement of the shaft into an axial movement parallel to the main rotational axis.

11. The electric wheel hub drive of claim 10, wherein the axial displacement device has a pinion connected to the shaft to conjointly rotate.

12. The electric wheel hub drive of claim 11, wherein the axial displacement device has a first ramp ring coupled to the pinion via a tooth engagement and a second ramp ring connected to the stator carrier via a groove of the stator carrier to conjointly rotate.

13. The electric wheel hub drive of claim 9, further comprising:
a cover arranged over the servomotor on the side thereof facing away from the wheel carrier.

14. The electric wheel hub drive of claim 12, wherein the second ramp ring has a shift fork engaging into a groove of the first coupling half so that the first coupling half is axially movable together with the second ramp ring.

15. The electric wheel hub drive of claim 12, wherein the first ramp ring has a ramp engaged with a counter-ramp of the second ramp ring so that rotation of the first ramp ring causes an axial movement of the second ramp ring.
